(19) United States
(12) Patent Application Publication
(10) Pub. No.: US 2011/0047371 A1
(43) Pub. Date: Feb. 24, 2011

(54) SYSTEM AND METHOD FOR SECURE DATA SHARING

(76) Inventor: Benjamin William Timby, Indianapolis, IN (US)

Correspondence Address: Woodard, Emhardt, Moriarty, McNett & Henry LLP, 111 Monument Circle, Suite 3700, Indianapolis, IN, 46204-5137, US

(21) Appl. No.: 12/543,218

(22) Filed: Aug. 18, 2009

(51) Int. Cl. G06F 12/14; H04L 9/00; H04L 9/32

(52) U.S. Cl. 713/153; 713/189; 726/28; 380/47; 713/168; 713/172

(57) ABSTRACT

A system and method for providing secure data storage and retrieval is disclosed. The system utilizes a protocol for distributing authentication tokens amongst potential recipients of information. Digital information is then disseminated via the system to authorized recipients. Various types of hardware and software authentication devices may be utilized to provide additional security during the storage and retrieval processes.

The present invention relates generally to data storage systems and, more particularly, to online data storage services having secure access for multiple users

### BACKGROUND

Various systems for providing secure access to digitally-stored data are known in the art. However, there is a need for improved systems which provide improved security while at the same time, providing ease of use and faster transfer speeds.

### SUMMARY

The present invention provides an improved system and method for providing secure access to digitally stored data for multiple users. The claims, and only the claims, define the invention.

The present invention may include a two-layer authentication process for storing and retrieving digital data in a remote computing environment. The authentication process may further include a hybrid encryption process wherein an intermediary encryption key is used to encrypt data to be stored, with the intermediary key itself being encrypted using a second encryption key.

One object of the present invention is to provide an improved system and method for providing secure storage and access of digital data in a remote computing environment.

### BRIEF DESCRIPTION OF THE DRAWINGS

FIG. 1 is schematic block diagram of a system for storing and accessing digital data according to one embodiment of the present disclosure.

FIG. 2 is a process flow diagram of a method for storing data according to one embodiment of the present disclosure.

FIG. 3 is a process flow diagram of a method for retrieving stored data according to one embodiment of the present disclosure.

FIG. 4 is a process flow diagram of a method for providing access to data to a third party according to one embodiment of the present disclosure.

### BRIEF DESCRIPTION OF THE PREFERRED EMBODIMENTS

For the purposes of promoting an understanding of the principles, reference will now be made to the embodiments illustrated herein and specific language will be used to describe the same. It will nevertheless be understood that no limitation of the scope of the invention is thereby intended. Any alterations and further modifications in the described processes, systems or devices, any further applications of the principles of the invention as described herein, are contemplated as would normally occur to one skilled in the art to which the invention relates, now and/or in the future.

As used in the claims and the specification, the following terms have the following definitions:

The term “authentication token” means a physical device which contains authentication data such as an encryption key. This may include, but is not limited to, a key fob, credit card sized plastic card, mobile phone, PDA, RFID device, Bluetooth device or USB device.

The term “asymmetric encryption algorithm” means a data encryption process whereby a first encryption key is used to encrypt a data file and a second encryption key is required to decrypt the data file. A user attempting to decrypt data using asymmetric encryption does not need access to the key that was used to encrypt the data. One non-limiting example of this is the Rivest Shamir Adleman (RSA) encryption algorithm. Other examples include, Digital Signature Algorithm (DSA), ElGamal, Paillier and Cramer-Shoup algorithms.

The terms “alpha,” “beta” and “gamma” are simple designators and do not necessarily imply a relative priority level.

The term “client computer” means a personal computer, laptop computer, handheld wireless computing device, mobile phone, PDA, or any other electronic digital device capable of connecting to a network and processing digital data.

The term “data partition” means a logical subset of the available data storage space of a digital storage device. This may optionally include physical subsets which are physically continuous or non-continuous. This may also optionally include subsets which physically overlap or are dispersed within other physical or logical subsets. This may be in a single server, or multiple servers, or otherwise. They may reside at the same or different physical locations.

The term “digital” means using numeric digits, specifically including binary digits.

The term “digital certificate” means an electronic document which uses a digital signature to bind together an encryption key with an identity such as the name of a person or computer account. One non-limiting example of this is an X509 certificate. Other examples may include Pretty Good Privacy (PGP), Simple Public Key Infrastructure (SPKI) and Simple Distributed Security Infrastructure (SDSI) certificates.

The term “digital storage device” means an electronic device which is capable of storing digital data. This includes, but is not limited to hard disk drives, floppy disk drives, flash devices (such as a jump drives or SD cards), optical drives such as a compact disc (CD) drives, digital versatile disc (DVD) drives, HD DVD drives, BLUE-RAY DVD drives, or another magnetic, solid state, or optical data storage devices, along with the associated medium (a floppy disk, a CD-ROM, a DVD, etc.).

The term “eradicating” means to electrically and/or physically erase or destroy data or access to data from a digital storage medium. This may include, but is not limited to, file deletion, overwrite operations, and digital file shredding.

The term “generating” means to make or create.

The term “key” means a piece of special knowledge used as a basis for encrypting or decrypting data.

The term “network” means a local area network (LAN), a Wide Area Network (WAN), or the internet. This may further comprise both wired and wireless connections and may utilize multiple formats to accomplish connectivity including, but not limited to, traditional phone lines, cellular phone systems, digital subscriber lines, cable modems, Wi-Fi networks, and the like.

The term “outside party” means a person who may or may not have access privileges to a digital storage server.

The term “physically remote” means in a separate physical location. This includes, but is not limited to, locations at separate postal mailing addresses.

The term “secure location” means a location whereby security measures have been taken to control human access. This includes, but is not limited to, bank vaults and other locked storage facilities.

The term “server” means an electronic computing device capable of receiving and transmitting data over a network. This includes, but is not limited to, rack-mountable or blade servers, personal computers, workstation computers, or the like. A server may also include a processor and memory for performing various functions necessary to achieve encryption, storage, retrieval, and decryption of data on a data storage device.

The term “smart card device” means a hand-held physical device containing embedded electronics capable of processing data. One non-limiting example of this is the eToken PRO authentication token supplied by Alladin Knowledge Systems. Others may include BESTOKEN, Syprus Rosetta Series II, Safenet iKey, CryptoCombo ITSEC-I, ActivIdentity ActivKey and ARX Minikey. The smart card device may be configured to connect to a computer using a Universal Serial Bus (USB) connection or other specialized reader interface.

The term “storing” means to electronically replicate data in a digital storage device for later retrieval.

The term “string” means an ordered sequence of symbols in an electronic format.

The term “system administrator” means one or more person(s) designated to perform maintenance or provide assistance to users of a computer system. This also includes computer accounts which are associated with persons who have been designated as system administrators.

The term “symmetric encryption algorithm” means a data encryption process whereby a single encryption key is used to both encrypt a data file and decrypt the data file. One non-limiting example of this is the American Encryption Standard (AES) encryption algorithm. Others may include the Twofish, Serpent, Blowfish, CAST5, RC4, 3DES and IDEA algorithms.

The term “URL string” means a Uniform Resource Locator string which contains the information necessary to locate a file on a remote network device.

The term “user” means a person or associated computer account which has been granted privileges to access a computer system.

The inventions are not limited to what is described below and shown in the drawings; rather this is merely an example. The inventions are what is cited in the claims.

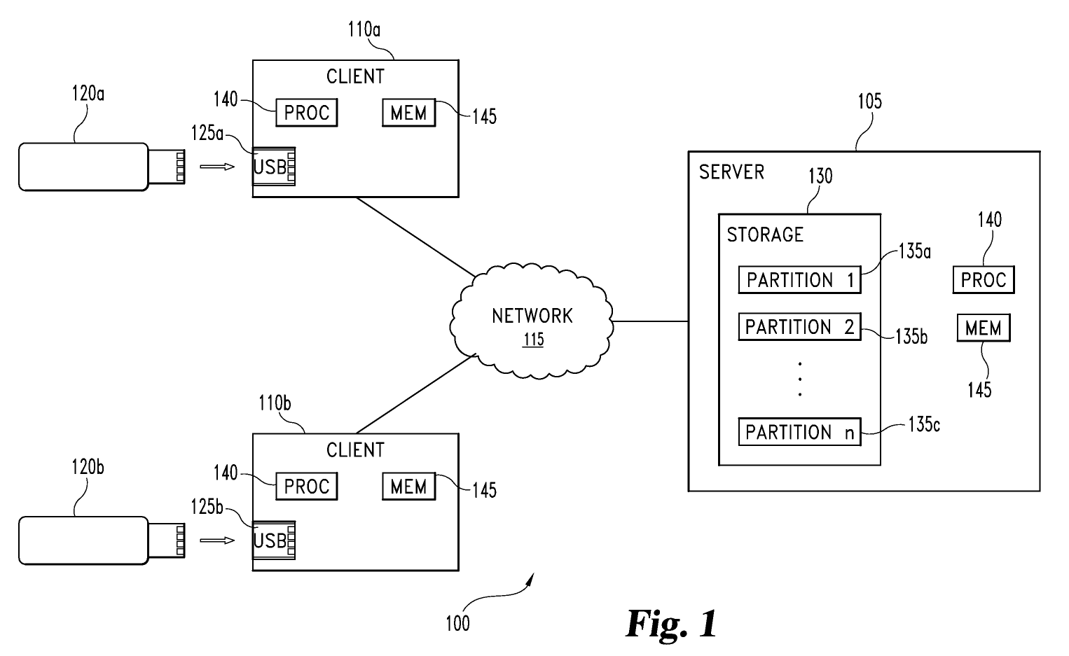

Turning to FIG. 1, a system 100 for providing secure data storage and retrieval for multiple users in a remote storage hosting environment is shown. The system may include a server 105 and clients 110 which are in communication with the server 105 via network 115. The clients 110 may optionally be remotely located from the server 105.

The system 100 may optionally include authentication tokens 125 which are issued to users of the system 100 and are connectable to client computers 110 via USB ports 125. The authentication tokens 120 may optionally comprise a smart card device. The authentication tokens 120 may be optionally configured to connect to client computers 110 using other types of interfaces, including, but not limited to specialized smart card readers, Firewire interfaces, Integrated Drive Electronics (IDE) interfaces and the like.

Server 105 may include a digital storage device 130, which may be divided into multiple data partitions 135. The server 105 may also include one or more processors 140 and memory 145. Likewise, client computers 110 may also comprise processors 140 and memory 145, along with other hardware to achieve connectivity with the server 105 via network 115.

In a preferred embodiment, the administrator of the system 100 assigns each partition 135 to a separate user. Each user is then able to upload data from a client computer 110 to their assigned partition 135 on the server 105. In addition, each user is able to grant access to their partition to additional users based on the authentication protocol described below. When the system is implemented as a storage hosting service, each partition 135 can be assigned to a different paying user such that each paying user is confined to use of their assigned partition. If the paying user chooses to grant access to additional parties, normally those parties will only have access to the paying user's partition.

The system 100 utilizes a variety of methods to secure data stored on the server 105. The choice of method typically depends on the needs of the user. In one embodiment, a username and password are required in order for a user to be authenticated. In another embodiment, a one-time password is used which requires the user to utilize a time-based password using a secret embedded device. As the embedded secret is difficult to steal or clone, physically possessing the device is required for authentication. A higher level of security can be achieved since the device cannot be stolen using means commonly used to steal passwords.

In still another embodiment, a digital certificate is utilized to authenticate a user. The digital certificate is installed on the client 110 by the system administrator and cannot be moved to another client 110 by the user. This ensures that normally only authorized client computers 110 are used for authentication. The digital certificate contains a key pair and digital signatures proving the key pair's authenticity. The key pair consists of two keys, one for encrypting data (referred to as a “public key”) and one for decrypting data (referred to as a “private key”). The digital certificate may be optionally configured to allow access to the public key while protecting access to the private key. The public keys for all digital certificate users may also be optionally stored on the server 105 for easy retrieval during the encryption process.

The data files and intermediary keys being stored on the server 105 may be encrypted using either a symmetric encryption process or an asymmetric encryption process. Asymmetric encryption can be very slow when compared to symmetric encryption, however the increased security of asymmetric encryption is often desirable.

In still another embodiment, the digital certificate is normally stored on an authentication token 120. The authentication token 120 is read by the client computer 110. Like the digital certificate, the authentication token 120 may optionally be configured to allow access to a public key while protecting access to the private key. Again, normally the public keys for all registered token users are stored on the server 105 for use in the encryption process.

When very large data files are to be transferred by a user to or from the server 105, the use of asymmetric encryption can be slow. It may therefore be desirable to employ symmetric encryption to encrypt the data. In order to provide an added measure of security to the symmetric encryption process, the key which is used to encrypt the bulk data (referred to as an intermediary key) may itself be encrypted using asymmetric encryption. The asymmetric encryption of the intermediary key is not time intensive since the intermediary key file is quite small when compared to a typical bulk data file. This dual format encryption process allows the bulk data to be quickly encrypted using symmetric encryption while still providing the security of asymmetric encryption for the intermediary key. A new intermediary key will be generated by the system each time data is stored and will be eradicated after the encryption to prevent the possibility of unauthorized access.

To retrieve the stored data, the user must connect the authentication token 120 to the client computer 110 or make the retrieval request from a client computer 110 which has been loaded with the digital certificate. When the request is initiated, the user's private key normally will be used to decrypt the intermediary key. The intermediary key can then be sent back to the server 105 and used to decrypt the data. In addition to the encryption being performed prior to storage on the server 105, all data passing over the network, including the desired data and the intermediary key, may optionally be encrypted/decrypted using a network encryption algorithm such as Secured Sockets Layer (SSL) or Transport Layer Security (TLS) when being sent over the network 115. It shall be understood that additional network encryption algorithms known in the art may be utilized.

If the inputting user wishes to grant access to stored data to another user, the inputting user's authentication token 120 or digital certificate will be used to decrypt the intermediary key. The intermediary key is then re-encrypted using the recipient's public key and stored on the server 105. In this way, the inputting user is able to digitally escrow data such that the inputting user no longer has the ability to access the data once the intermediary key has been re-encrypted using the recipient's public key. If the inputting user wishes to retain access to the stored data (in addition to the recipient), the encrypted copy of the intermediary key (which was originally encrypted using the inputting user's public key) is retained on the server 105. The recipient user is then able to decrypt the intermediary key using the recipient private key embedded in the recipient's authentication token 120 or digital certificate.

If the user or recipient loses their digital certificate or authentication token 120 due to hardware failure or loss, the intermediary key normally would not be able to be decrypted and the data may be permanently lost. To combat this, the system itself may be issued a key pair. The public key of the system key pair is then stored on the server 105 along with the public keys of the registered users. An authentication token 120 or other storage medium containing the corresponding private key may then be stored in a physically remote secure location. If an inputting user chooses for their data to be stored in a recoverable manner, the system's public key may be used to create an additional encrypted copy of the intermediary key each time data is stored to the server 105. In the case that all users having access to the data have lost their authentication tokens 125 or digital certificates, the private key of the system's key pair may be retrieved from the secure location and used to recover the data. The data can then be re-encrypted using a newly generated intermediary key. The user and/or recipient may be issued a new authentication token 125 or digital certificate and the new public key used to encrypt the new intermediary key.

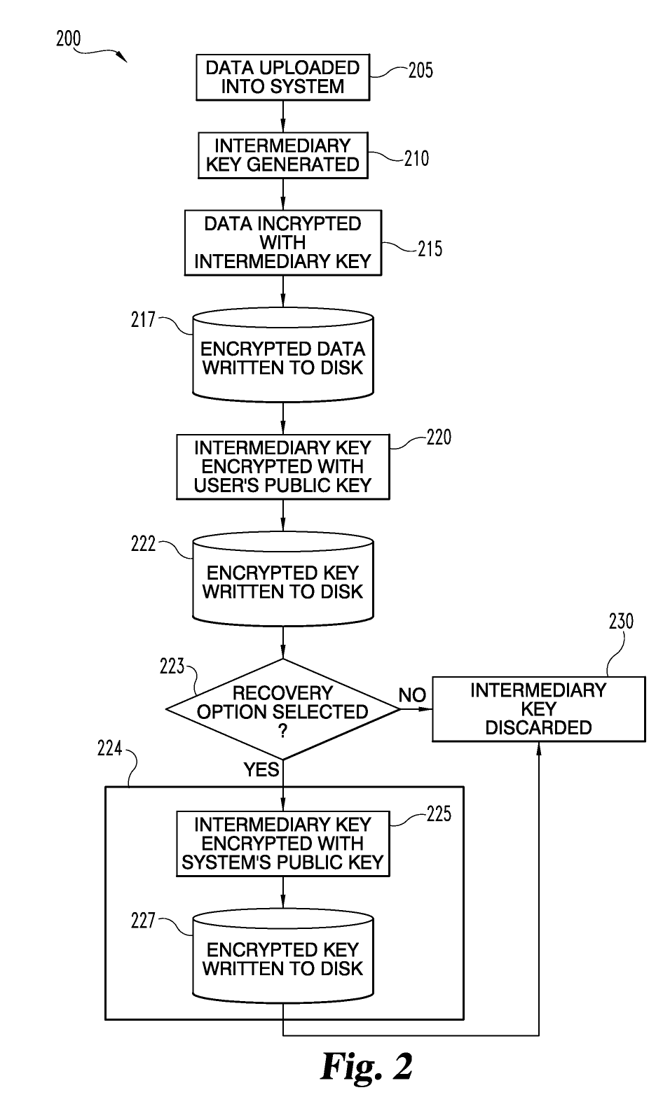

FIG. 2 illustrates one example process for storing data on the server 105 according to one embodiment. The process begins at step 205 where the inputting user uploads data to the server 105 from client 110. Once the server 105 receives the data, typically a unique intermediary encryption key is generated at step 210. At step 215, the uploaded data is encrypted using a symmetric encryption process based on the intermediary key and stored within the user's partition 135 on the server 105 (step 217). After the data has been encrypted and stored, the public key for the inputting user is typically retrieved and used to encrypt the intermediate key using an asymmetric encryption process (step 220). At step 222, the encrypted intermediary key is typically saved on the user's partition 135 along with the encrypted bulk data.

If the inputting user wishes to be able to recover the stored data in the event his authentication token 120 or digital certificate is lost, the intermediary key is optionally encrypted a second time, using the system public key at step 225. The second encrypted copy of the intermediary key is then saved to the user's partition 135 for later retrieval at step 227. After the encryption process is complete, the intermediary key may be eradicated from the memory 105 and digital storage device 130 of the server 105.

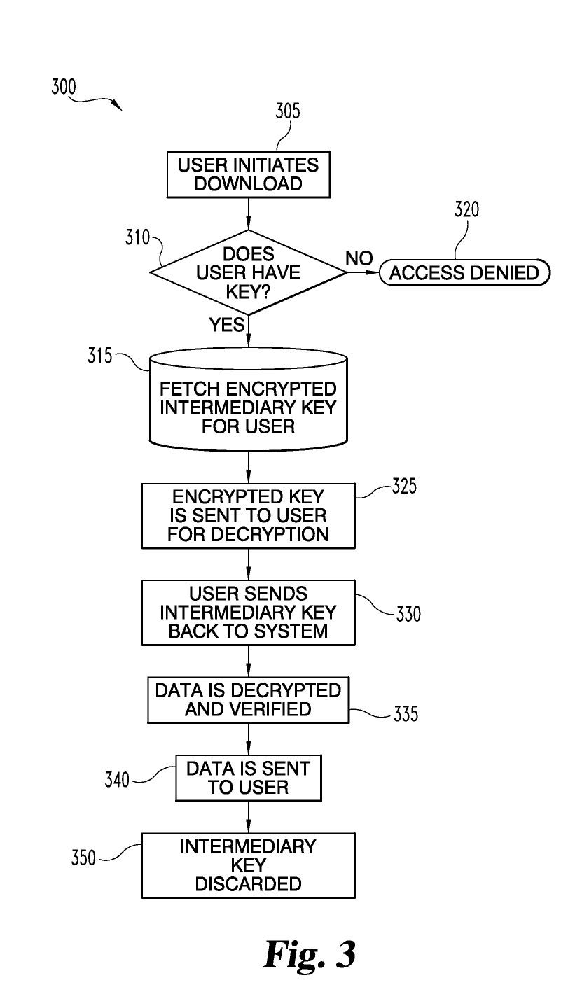

Turning to FIG. 3, a process 300 for retrieving stored data from the server 105 is shown. The process begins at step 305 where the user initiates a download request from the client computer 110. If the digital certificate or authentication token 120 associated with the user is not detected by the client computer 110 (decision block 310), the user is normally denied access at step 320. If the correct digital certificate or authentication token 120 is present, the encrypted intermediary key associated with the encrypted data is typically retrieved from the server 105 (step 315) and sent to the client computer (step 325). The intermediary key may be then decrypted by the client computer 110 using an asymmetric decryption algorithm based on the user's private key and returned to the server 105 (step 330). As discussed above, if the inputting user had chosen the recovery option when storing the data, either the digital certificate/authentication token 120 of the inputting user or the digital certificate/authentication token 120 of the system 100 may be used to decrypt the intermediary key.

Once the server 105 receives the decrypted intermediary key, the stored data is decrypted and verified using a symmetric decryption algorithm based on the intermediary key (step 335). The decrypted data is then sent to the user's client computer 110 (step 340) and the intermediary key may be eradicated from the system (step 350).

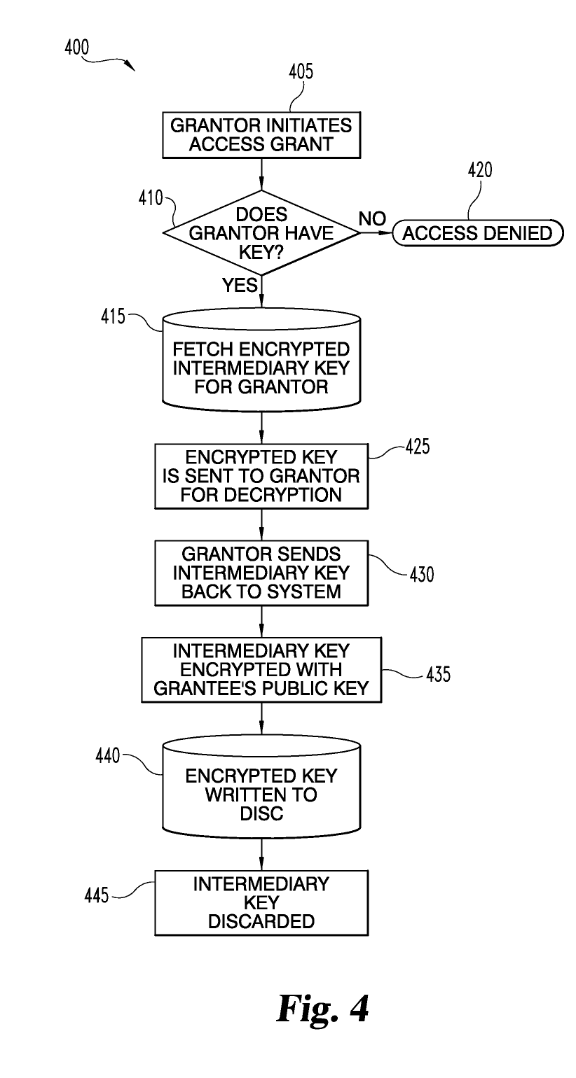

Turning to FIG. 4, an example process 400 for granting access to previously stored data is illustrated. The process begins at step 405 where the grantor (typically the inputting user) requests that access to the stored data be granted to another user. If the digital certificate or authentication token 120 associated with the grantor is not detected by the client computer 110 (decision block 410), the grantor will normally be denied access (step 420). If the correct digital certificate or authentication token 120 is present, the encrypted intermediary key associated with the encrypted data is typically retrieved from the server 105 (step 415) and sent to the client computer 110 (step 425).

At step 430, the intermediary key is normally decrypted by the client computer 110 using an asymmetric decryption based on the grantor's private key and returned to the server 105. Once the server 105 receives the decrypted intermediary key, the intermediary key may be re-encrypted using an asymmetric encryption algorithm based on the grantee's public key (step 435). The re-encrypted intermediary key may be then saved to the partition 135 containing the stored data at (step 440) and the unencrypted intermediary key is eradicated from the system (step 445). If the grantor has chosen to transfer exclusive access rights to the grantee, wherein the grantor will typically no longer have access to the stored data, the original copy of the encrypted intermediary key (which was encrypted using the grantor's public key) may be optionally erased from the server 105.

In another embodiment, the grantor is able to select a “public link” option, wherein a Uniform Resource Locator (URL) string will be generated which is associated with a file stored within the user's partition on the server 105. The user may then provide the URL string to one or more outside parties, allowing the parties to access the file without the use of an encryption key. The URL string may optionally include the web address of the server 105 in addition to a randomly generated number which is assigned to the file. In certain embodiments, the URL string may be optionally configured to expire after a specified date or amount of time, thereby preventing the outside party from accessing the file after that date or time. In still further embodiments, the URL string may be optionally configured to expire after a specific number of access operations.

The present invention contemplates modifications as would occur to those skilled in the art. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

We claim:

1. A method of securing data within remote computer storage, comprising the acts of:
providing at least two data partitions within a digital storage device, a first one of said data partitions being associated with and remotely accessible by at least one user;
generating a first alpha key and a first beta key associated with a first user, said first alpha key and said first beta key being related through an asymmetric encryption algorithm;
storing the first alpha key on the digital storage device;
storing the first beta key on at least one of a first client computer and a first authentication token associated with said first user;
receiving a first data file from the first client computer;
generating a first gamma key associated with said first data file;
generating a first encrypted copy of the first data file by applying a symmetric encryption algorithm to the first data file based on the first gamma key;
storing said first encrypted copy of the first data file on the first partition;
generating a first encrypted copy of the first gamma key using an asymmetric encryption algorithm based on the first alpha key;
storing said first encrypted copy of the first gamma key on the digital storage device; and
eradicating said first gamma key in unencrypted form from said digital storage device.

2. The method of claim 1, further comprising:
generating a second alpha key and a second beta key associated with a second user, said second alpha key and said second beta key being related through an asymmetric encryption algorithm;
storing the second alpha key on the digital storage device;
storing the second beta key in a physically remote secure location, wherein said system administrator does not have access to the physically remote secure location;
generating a second encrypted copy of the first gamma key using an asymmetric encryption algorithm based on the second alpha key; and
storing said first encrypted copy of the first gamma key on the digital storage device.

3. The method of claim 2, wherein said second user is a system administrator.

4. The method of claim 2, wherein said second user is not a system administrator.

5. The method of claim 3, further comprising:
receiving a request from the first client computer to retrieve said first data file;
transmitting the first encrypted copy of the first gamma key to the first client computer;
receiving the first gamma key from the first client computer;
decrypting the first data file using a symmetric decryption process based on the first gamma key; and
transmitting the first data file to the first client computer.

6. The method of claim 5, further comprising:
receiving a request from the first client computer to grant a third user access to said first data file;
transmitting the first encrypted copy of the first gamma key to the first client computer;
receiving the first gamma key from the first client computer;
generating a third alpha key and a third beta key associated with the third user, said third alpha key and said third beta key being related through an asymmetric encryption algorithm;
storing the third alpha key on the digital storage device;
storing the third beta key on at least one of a second client computer and a second authentication token associated with said third user;
generating a second encrypted copy of the first gamma key using an asymmetric encryption algorithm based on the third alpha key;
storing said second encrypted copy of the first gamma key on the digital storage device; and
eradicating said first gamma key in unencrypted form from said digital storage device.

7. The method of claim 6,
wherein the first one of said data partitions is associated with and accessible by the first user;
wherein a second one of said data partitions is associated with and accessible by a fourth user;
wherein the first user does not have access to the second one of said data partitions; and
wherein the fourth user does not have access to the first one of said data partitions.

8. The method of claim 7, wherein said first client computer is configured to run software for decrypting said first encrypted copy of said first gamma key while protecting access to said first beta key.

9. The method of claim 8, wherein said first beta key is stored within a digital certificate.

10. The method of claim 9, wherein said digital certificate is stored within an authentication token.

11. The method of claim 10, wherein said authentication token is a smart card device.

12. The method of claim 1, further comprising:
receiving a request from the first client computer to retrieve said first data file;
transmitting the first encrypted copy of the first gamma key to the first client computer;
receiving the first gamma key from the first client computer;
decrypting the first data file using a symmetric decryption process based on the first gamma key; and
transmitting the first data file to the first client computer.

13. The method of claim 1, further comprising:
receiving a request from the first client computer to grant a second user access to said first data file;
transmitting the first encrypted copy of the first gamma key to the first client computer;
receiving the first gamma key from the first client computer;
generating a second alpha key and a second beta key associated with the second user, said second alpha key and said second beta key being related through an asymmetric encryption algorithm;
storing a copy of the second alpha key on the digital storage device;
storing a copy of the second beta key on at least one of a second client computer and a second authentication token associated with the second user;
generating a second encrypted copy of the first gamma key using an asymmetric encryption algorithm based on the second alpha key;
storing said second encrypted copy of the first gamma key on the digital storage device; and
eradicating said first gamma key in unencrypted form from said digital storage device.

14. The method of claim 1,
wherein the first one of said data partitions is associated with and accessible by the first user;
wherein a second one of said data partitions is associated with and accessible by a second user;
wherein the first user does not have access to the second one of said data partitions; and
wherein the second user does not have access to the first one of said data partitions.

15. The method of claim 1, wherein said first client computer is configured to run software for decrypting said first encrypted copy of said first gamma key while protecting access to said first beta key.

16. The method of claim 1, wherein said first client computer is not configured to run software for decrypting said first encrypted copy of said first gamma key while protecting access to said first beta key.

17. The method of claim 1, wherein said first beta key is stored within a digital certificate.

18. The method of claim 1, wherein said first beta key is not stored within a digital certificate.

19. The method of claim 1, wherein said first beta key is stored within an authentication token.

20. The method of claim 1, wherein said first beta key is not stored within an authentication token.

21. The method of claim 19, wherein said authentication token is a smart card device.

22. The method of claim 19, wherein said authentication token is not a smart card device.

23. A method of providing access to data secured within remote computer storage, comprising the acts of:
providing at least two data partitions within a digital storage device, a first one of said data partitions being associated with and remotely accessible by a first user, a second one of said data partitions being associated with and remotely accessible by a second user;
generating a URL string associated with a first file stored within the first partition; and
providing said URL string to a third user not associated with the first partition;
wherein the URL string allows the third user to access the first file for at least one of a limited date range and a limited number of access operations.
